(19) United States
(12) Patent Application Publication
(10) Pub. No.: US 2016/0189199 A1
(43) Pub. Date: Jun. 30, 2016

(54) METHOD AND SYSTEM FOR UTILIZING ADVERTISEMENT SKIPPING BUDGET BEHAVIOR

(71) Applicant: Sanjeev Madhava Rao, Manhattan Beach, CA (US)

(72) Inventor: Sanjeev Madhava Rao, Manhattan Beach, CA (US)

(21) Appl. No.: 14/587,224

(22) Filed: Dec. 31, 2014

(51) Int. Cl. G06Q 30/02

(52) U.S. Cl. CPC G06Q 30/0242; G06Q 30/0249

(57) ABSTRACT

The present disclosure provides a method and system for analyzing advertisement skipping budget behavior of one or more users. The method includes capturing an advertisement skipping budget behavior of each of one or more users for one or more advertisements in corresponding one or more content, and analyzing the captured advertisement skipping budget behavior of each of the one or more users. The advertisement skipping budget behavior is recorded for a pre-defined interval of timebased on a real-time skipping criterion.

### TECHNICAL FIELD

The present invention relates to the field of advertising and in particular relates to utilizing advertisement skipping budget behavior of one or more users for one or more advertisements.

### BACKGROUND

Advertising is an ever evolving industry which functions on a fact of survival of the fittest. The advertisements serve as a medium for consumers to explore various online and offline services. Many publishers have started displaying advertisements in content. However, the advertisements shown in the content irritates a user. The user gets interrupted every time when the advertisements are encountered in viewing of the content. In such a case, it is a big concern for the publishers in terms of their revenue generation strategy as it is least likely that the user will take action on the shown advertisement.

Generally, publishers allow the users to skip the advertisements shown in the content by charging a fee from them. Many users prefer to skip the advertisements that are shown in the content. However, this hinders marketing and advertising strategies of advertisers that want to advertise their product. Moreover, targeting and re-targeting of the advertisements by advertisement re-targeting networks is also affected.

Currently, there is no method and system that can provide effective re-targeting of the advertisements along with considering the fact that the users skip most of the advertisements shown in the content. Further, there is no method and system that could provide sufficient data to advertisement networks to help them advertise their products effectively to right category of consumers.

In the light of the above stated discussion, there is a need for a method and system that overcomes the above stated disadvantages of the present methods.

### SUMMARY

In an aspect of the present disclosure, a computer-implemented method for analyzing advertisement skipping budget behavior of one or more users is provided. The computer-implemented method includes capturing, with a processor, an advertisement skipping budget behavior of each of one or more users for one or more advertisements in corresponding one or more content and analyzing, with the processor, the captured advertisement skipping budget behavior of each of the one or more users. The advertisement skipping budget behavior is recorded for a pre-defined interval of timebased on a real-time skipping criterion.

In an embodiment of the present disclosure, the advertisement skipping budget behavior is captured for an advertisement of each of the one or more advertisements in the corresponding one or more content.

In another embodiment of the present disclosure, the advertisement skipping budget behavior is captured for the one or more advertisements in a content of the one or more content.

In an embodiment of the present disclosure, the computer-implemented method further includes correlating, with the processor, data of each of the one or more users with the advertisement skipping budget behavior of each of the corresponding one or more users. The data is based on a plurality of attributes corresponding to each of the one or more users. The plurality of attributes includes at least one of age, gender, interest and browsing history.

In an embodiment of the present disclosure, the computer-implemented method further includes categorizing, with the processor, the one or more users based on the correlation of the advertisement skipping budget behavior of each of the corresponding one or more users for the one or more advertisements, with the data of the corresponding one or more users.

In an embodiment of the present disclosure, the computer-implemented method further includes maintaining a database, with the processor, of each of the one or more users. The database includes the advertisement skipping budget behavior of each of the one or more users, the data corresponding to each of the one or more users and the categorized one or more users.

In an embodiment of the present disclosure, the computer-implemented method further includes transmitting, with the processor, the advertisement skipping budget behavior of each of the corresponding one or more users, and the data corresponding to each of the one or more users to one or more third parties for re-targeting of each of the one or more advertisements. The one or more third parties include at least one of one or more advertising platforms and one or more advertisement re-targeting platforms.

In another embodiment of the present disclosure, the advertisement skipping budget behavior is captured for the one or more advertisements in a content of the one or more content.

In another aspect of the present disclosure, a computer system is provided. The computer system includes a non-transitory computer readable medium storing a computer readable program; the computer readable program when executed on a computer causes the computer to perform steps. The steps include capturing an advertisement skipping budget behavior of each of one or more users for one or more advertisements in corresponding one or more content and analyzing the captured advertisement skipping budget behavior of each of the one or more users. The advertisement skipping budget behavior is recorded for a pre-defined interval of time based on a real-time skipping criterion.

In an embodiment of the present disclosure, the computer readable program when executed on the computer causes the computer to perform the step of categorizing the one or more users based on a correlation of the advertisement skipping budget behavior of each of the corresponding one or more users for the one or more advertisements, with data of the corresponding one or more users, the data is based on the plurality of attributes corresponding to each of the one or more users, the plurality of attributes includes at least one of age, gender, interest and browsing history.

In an embodiment of the present disclosure, the computer readable program when executed on the computer causes the computer to perform the step of transmitting the advertisement skipping budget behavior of each of the corresponding one or more users, and data corresponding to each of the one or more users to one or more third parties for re-targeting of each of the one or more advertisements.

In yet another aspect of the present disclosure, an analytical and recommendation engine is provided. The analytical and recommendation engine includes a capturing module in a processor to capture an advertisement skipping budget behavior of each of one or more users for one or more advertisements in corresponding one or more content and an analyzing module in the processor to analyze the captured advertisement skipping budget behavior of each of the one or more users. The advertisement skipping budget behavior is recorded for a pre-defined interval of time based on a real-time skipping criterion.

In an embodiment of the present disclosure, the analytical and recommendation engine further includes a correlation engine in the processor to correlate data of each of the one or more users with the advertisement skipping budget behavior of each of the corresponding one or more users. The data is based on a plurality of attributes corresponding to each of the one or more users. The plurality of attributes includes at least one of age, gender, interest and browsing history.

In an embodiment of the present disclosure, the analytical and recommendation engine further includes a categorization module in the processor to categorize the one or more users based on the correlation of the advertisement skipping budget behavior of each of the corresponding one or more users for the one or more advertisements, with the data of the corresponding one or more users.

In an embodiment of the present disclosure, the analytical and recommendation engine further includes a database in the processor of each of the one or more users. The database includes the advertisement skipping budget behavior of each of the one or more users, the data corresponding to each of the one or more users and the categorized one or more users.

In an embodiment of the present disclosure, the analytical and recommendation engine further includes a transmission module in the processor to transmit the advertisement skipping budget behavior of each of the corresponding one or more users, and the data corresponding to each of the one or more users to one or more third parties for re-targeting of each of the one or more advertisements. The one or more third parties include at least one of one or more advertising platforms and one or more advertisement re-targeting platforms.

In an embodiment of the present disclosure, the advertisement skipping budget behavior is captured for an advertisement of each of the one or more advertisements in the corresponding one or more content.

### BRIEF DESCRIPTION OF THE FIGURES

Having thus described the invention in general terms, reference will now be made to the accompanying drawings, which are not necessarily drawn to scale, and wherein:

FIG. 1 illustrates a system for analyzing advertisement skipping budget behavior of one or more users, in accordance with various embodiments of the present disclosure;

FIG. 2 illustrates a block diagram of an analytical and recommendation engine, in accordance with various embodiments of the present disclosure;

FIG. 3 illustrates a system for capturing the advertisement skipping budget behavior of the one or more users, in accordance with various embodiments of the present disclosure; and

FIG. 4 illustrates a flowchart for analyzing the advertisement skipping budget behavior of the one or more users, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

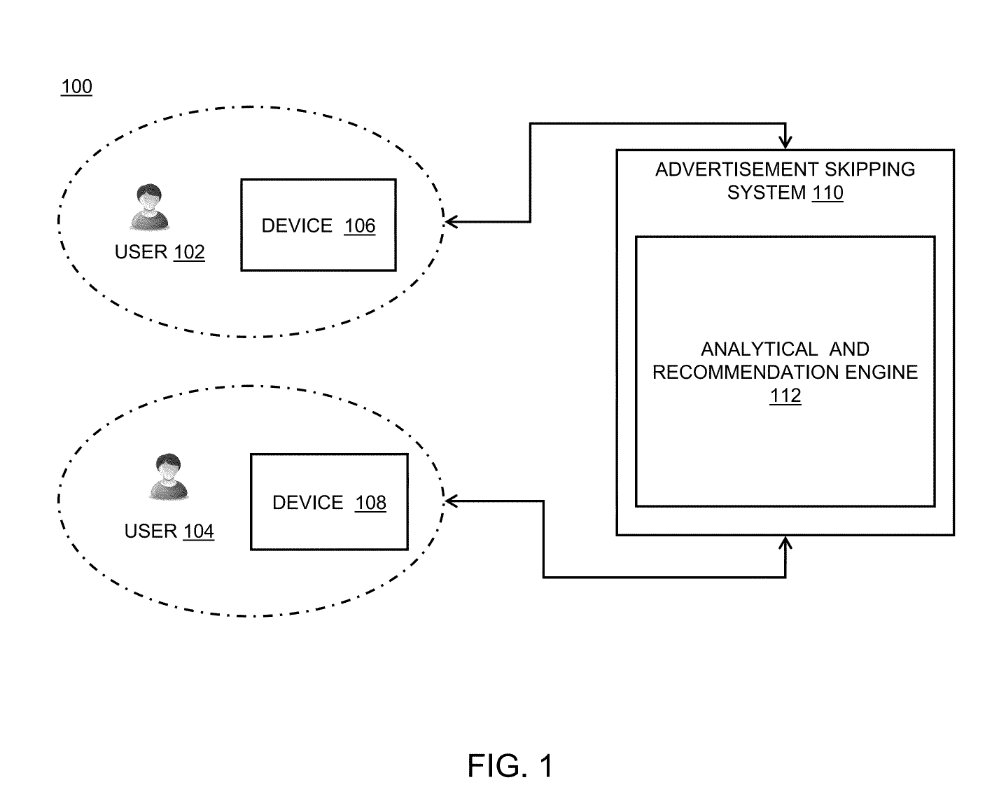

FIG. 1 illustrates a system 100 for analyzing advertisement skipping budget behavior of one or more users, in accordance with various embodiments of the present disclosure. The advertisement skipping budget behavior includes budget behavior of each of the one or more users for skipping one or more advertisements in corresponding one or more content. The one or more advertisements include audio advertisements, video advertisements, textual advertisements, rich media advertisements (for example, HTML), flash advertisements, survey/poll, advertisements for promoting and sponsoring real-life events including sports, charity, or music festivals and the like. The system 100 includes a device 106 associated with a user 102, a device 108 associated with a user 104, an advertisement skipping system 110 and an analytical and recommendation engine 112. The advertisement skipping system 110 includes the analytical and recommendation engine 112. Examples of the device 106-108 include but may not be limited to mobile phones, desktops, laptops, televisions or any other device known in the art which is capable of providing a content to be viewed by the user 102-104.

The advertisement skipping system 110 allows the user 102-104 to skip the one or more advertisements before/during viewing of the one or more content. The content may include an online content, an offline content, live content, delayed content and the like. In an embodiment of the present disclosure, the content may be packaged as a streaming content, video on demand, mobile applications, mobile games or any other content known in the art in which the advertisements can be inserted. Further, the content include but may not be limited to one or more audios, one or more videos, one or more rich media content (for example, HTML content), flash content, one or more textual content and one or more features (for example, in a game, when a user watches advertisements or accept offers to reach certain levels).

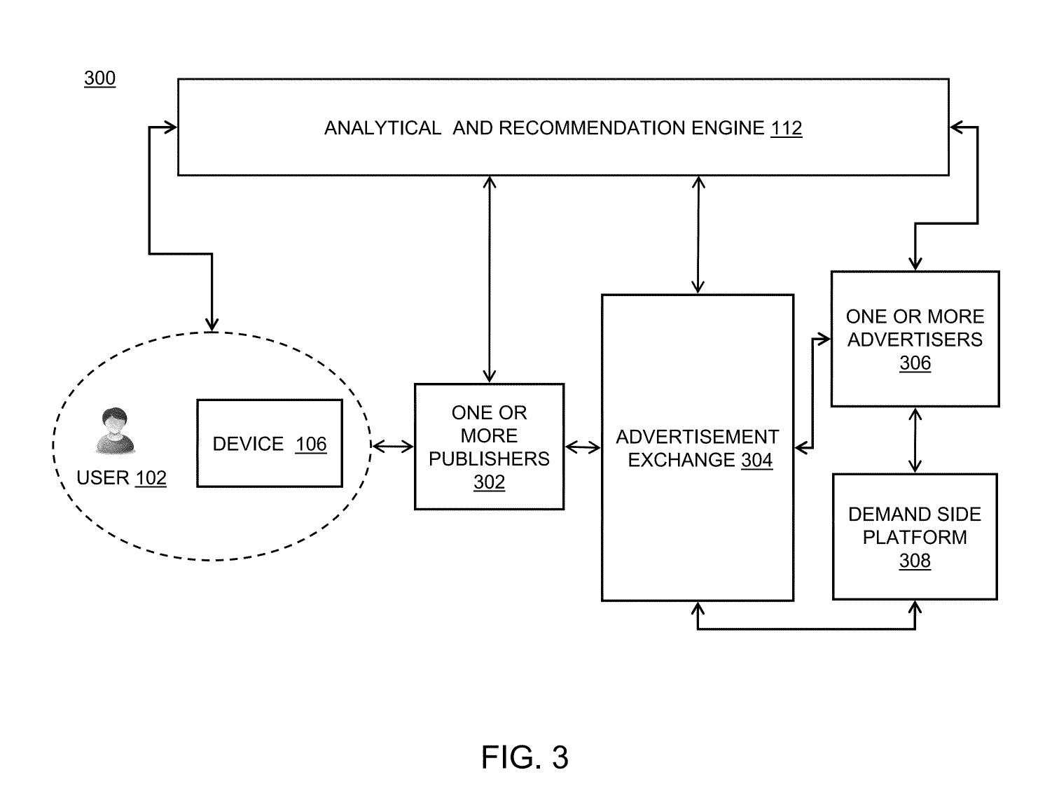

The user 102-104 pays a pre-determined amount for skipping the one or more advertisements in the corresponding one or more content. The pre-determined amount is based on a real time bidding algorithm (as described in detailed description of FIG. 3). In an embodiment of the present disclosure, the user 102-104 decides a budget for skipping the one or more advertisements in a content of the one or more content. The content may be based on choice or interest of the user 102-104. For example, a user X is fond of watching sports matches and pays an amount for skipping the one or more advertisements during broadcasting of the sports matches. In another embodiment of the present disclosure, the user 102-104 decides a budget for skipping the one or more advertisements in the one or more content. For example, a user Y gets irritated by encountering advertisements in the one or more content and pays the advertisement skipping system 110 for skipping every advertisement during watching of the one or more content. In yet another embodiment of the present disclosure, the user 102-104 may pay for skipping a particular type of advertisement of the one or more advertisements during watching of each of the one or more content. For example, a male user Z pays an amount for skipping advertisements related to female products during watching of each of the one or more content. In an embodiment of the present disclosure, the user 102-104 decides an amount to be paid by him/her for skipping the one or more advertisements in the one or more content and the advertisement skipping system 110 skips the advertisements accordingly. For example, if a user U has decided to spend $0.2 for skipping the one or more advertisements in the one or more content, then the advertisement skipping system 110 skips as many advertisements that can be easily skipped with this amount ($0.2).

The analytical and recommendation engine 112 captures and analyzes an advertisement skipping budget behavior of the user 102-104 for the one or more advertisements in the corresponding one or more content. The advertisement skipping budget behavior is recorded for a pre-defined interval of time based on a real-time skipping criterion (as exemplarily illustrated in detailed description of FIG. 3). The pre-defined interval of time may be a week, a month or a year. The analytical and recommendation engine 112 collects information related to skipping of the type of advertisements in different types of content seen by the user 102-104. For example, the analytical and recommendation engine 112 analyzes that the user X spends a huge amount in a month for skipping all the advertisements during the broadcasting of the sports matches. In another example, the analytical and recommendation engine 112 analyzes that the user Y spends a huge amount in a week for skipping all the advertisements of the one or more content.

Further, the analytical and recommendation engine 112 correlates data of the user 102-104 with the analyzed advertisement skipping budget behavior of the user 102-104. The data is based on a plurality of attributes corresponding to the user 102-104. The plurality of attributes includes age, gender, interest and browsing history before and after watching the one or more advertisements and the like. Furthermore, the analytical and recommendation engine 112 categorizes the user 102-104 based on the correlation of the advertisement skipping budget behavior for the one or more advertisements and the data of the corresponding one or more users. For example, one or more users who are spending an amount for skipping all the advertisements in content (say, during broadcasting of the sports matches) are placed in a group. In another example, one or more users who are spending money for skipping all the advertisements in the one or more content are placed in another group.

In addition, the analytical and recommendation engine 112 maintains a database of the user 102-104. The database includes the advertisement skipping budget behavior of the user 102-104, the data corresponding to the user 102-104 and one or more groups of users obtained after categorizing the user 102-104. The categorizing may be performed based on more criteria which include but may not be limited to ad skipping budget, behavior, total amount of money spend during a particular time period, age, gender, ethnicity, location, perusal and physical attributes, browsing information and the like.

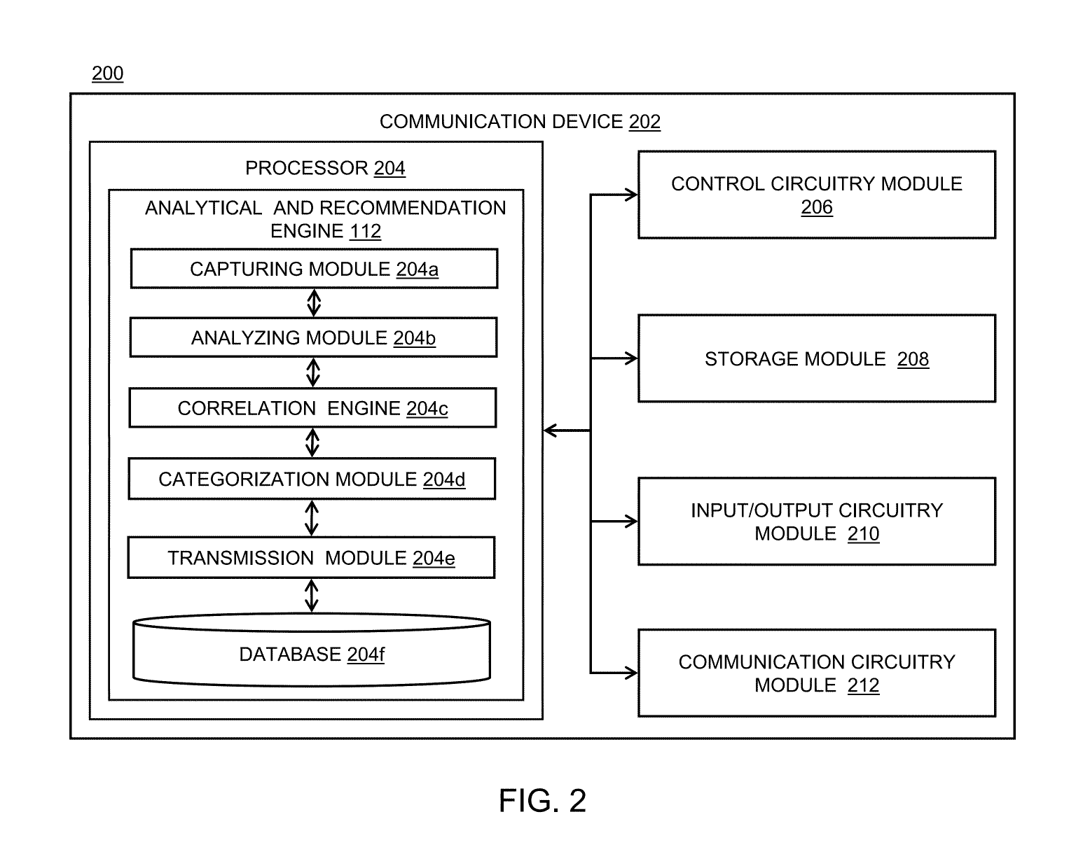

Further, the analytical and recommendation engine 112 transmits the advertisement skipping budget behavior of the user 102-104, and the data corresponding to the user 102-104 to one or more third parties for re-targeting of the one or more advertisements. The one or more third parties include one or more advertising platforms and one or more advertisement re-targeting platforms. The one or more advertising platforms include digital advertising networks, mobile advertising networks, on-demand interactive televisions and the like. Examples of the one or more advertising platforms include AdSense, AdWords and the like. The one or more advertisement re-targeting platforms include advertising companies/agencies that re-targets the advertisements to an audience (as exemplarily described in detailed description of FIG. 2).

It may be noted that in FIG. 1, the analytical and recommendation engine 112 analyzes the advertisement skipping budget behavior of the user 102-104; however, those skilled in the art would appreciate that the analytical and recommendation engine 112 may analyze the advertisement skipping budget behavior of more number of users. It may also be noted that the user 102 is associated with the device 106 and the user 104 is associated with the device 108; however, those skilled in the art would appreciate that each of the user 102-104 may be associated with more number of devices having capability of showing the one or more content to the user 102-104.

FIG. 2 illustrates a block diagram of a communication device 202, in accordance with various embodiments of the present disclosure. It may be noted that to explain the system elements of the FIG. 2, references will be made to the system elements of FIG. 1. The communication device 202 includes a processor 204, a control circuitry module 206, a storage module 208, an input/output circuitry module 210 and a communication circuitry module 212. Further, the processor 204 includes a capturing module 204a, an analyzing module 204b, a correlation engine 204c, a categorization module 204d, a transmission module 204e and a database 204f. The above stated components of the processor 204 enables the working of the analytical and recommendation engine 112 for analyzing the advertisement skipping budget behavior of the one or more users

The capturing module 204a captures the advertisement skipping budget behavior of the user 102-104 for the one or more advertisements in the corresponding one or more content (described in detailed description of FIG. 1). The advertisement skipping budget behavior is recorded for a pre-defined interval of timebased on a real-time skipping criterion (as exemplarily illustrated in detailed description of FIG. 3). The analyzing module 204b analyzes the captured advertisement skipping budget behavior of the user 102-104 (described in detailed description of FIG. 1).

Going further, the correlation engine 204c correlates data of the user 102-104 with the analyzed advertisement skipping budget behavior of the user 102-104. The data is based on the plurality of attributes including the age of the user 102-104, gender of the user 102-104, interest of the user 102-104, browsing history before and after watching the one or more advertisements and the like. The categorization module 204d categorizes the user 102-104 based on the correlation of the advertisement skipping budget behavior for the one or more advertisements and the data of the corresponding one or more users (described in the detailed description of FIG. 1). The analysis, the correlation and the categorization described above results into inferences that defines the interest of the user 102-104. It can now be found that which age group of users has spent how much money on skipping advertisements, skipped and watched what kind of advertisements. For example, male users belonging to an age group of 20-35 years male members spent almost 40 dollar on monthly basis is SF bay area (or some other attribute) to skip most of the advertisements during the broadcasting of the soccer content.

The transmission module 204e transmits the advertisement skipping budget behavior of the user 102-104, and the data corresponding to the user 102-104 to the one or more third parties for re-targeting of the one or more advertisements. The one or more third parties include the one or more advertising platforms and the one or more advertisement re-targeting platforms (described in the detailed description of FIG. 1). The one or more advertising platforms targets the audience based on information received by the transmission module 204e of the analytical and recommendation engine 112. For example, the one or more advertisement re-targeting platforms are now aware of the fact that the user X skips all the advertisements during broadcasting of the sports matches. These platforms now know that the user X is fond of sports; so, these platforms can show the advertisements related to sports products to him not during any sports match but during other content (say, a television show).

In an embodiment of the present disclosure, the one or more advertisement re-targeting platforms after knowing the fact that the user X skips all the advertisements during broadcasting of the sports matches, may increase bid for the one or more advertisement slots (these advertisement slots includes advertisements that the user X skips during the broadcasting of the sports matches) to increase their revenue. In another embodiment of the present disclosure, the one or more advertisement re-targeting platforms after knowing the fact that the user X skips all the advertisements during broadcasting of the sports matches, may reduce bid for the one or more advertisement slots. In an embodiment of the present disclosure, the re-targeting of the one or more advertisements is done by using digital fingerprinting when the device 106-108 is mobile phone. In an embodiment of the present disclosure, the transmission module 204e transmits a prior knowledge of likely non-performance of the one or more advertisements to the one or more third parties for targeting and the re-targeting of the one or more advertisements.

Going further, the database 204f stores the advertisement skipping budget behavior of the user 102-104, the data corresponding to the user 102-104 and the one or more groups of users obtained after categorizing the user 102-104.

It may be noted that in FIG. 2, the analytical and recommendation engine 112 includes the capturing module 204a, the analyzing module 204b, the correlation engine 204c, the categorization module 204d, the transmission module 204e and the database 204f; however those skilled in the art would appreciate that the analytical and recommendation engine 112 may include more number of modules that could explain the overall functioning of the analytical and recommendation engine 112.

Going further, the communication device 202 includes any suitable type of portable electronic device. Examples of the communication device 202 include but may not be limited to a personal e-mail device (e.g., a Blackberry™ made available by Research in Motion of Waterloo, Ontario), a personal data assistant (“PDA”), a cellular telephone, a Smartphone, a handheld gaming device, a digital camera, the laptop computer, and a tablet computer. In another embodiment of the present disclosure, the communication device 202 can be a desktop computer.

From the perspective of this disclosure, the control circuitry module 206 includes any processing circuitry or processor operative to control the operations and performance of the communication device 202. For example, the control circuitry module 206 may be used to run operating system applications, firmware applications, media playback applications, media editing applications, or any other application. In an embodiment, the control circuitry module 206 drives a display and process inputs received from a user interface.

From the perspective of this disclosure, the storage module 208 includes one or more storage mediums including a hard-drive, solid state drive, flash memory, permanent memory such as ROM, any other suitable type of storage component, or any combination thereof. The storage module 208 may store, for example, media data (e.g., music and video files), application data (e.g., for implementing functions on the communication device 202).

From the perspective of this disclosure, the I/O circuitry module 210 may be operative to convert (and encode/decode, if necessary) analog signals and other signals into digital data. In an embodiment, the I/O circuitry module 210 may also convert the digital data into any other type of signal and vice-versa. For example, the I/O circuitry module 210 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 206, the storage module 208 or any other component of the communication device 202.

The communication device 202 may include any suitable interface or component for allowing the user 102 to provide inputs to the I/O circuitry module 210. The communication device 202 may include any suitable input mechanism. Examples of the input mechanism include but may not be limited to a button, keypad, dial, a click wheel, and a touch screen. In an embodiment, the communication device 202 may include a capacitive sensing mechanism, or a multi-touch capacitive sensing mechanism.

In an embodiment, the communication device 202 may include specialized output circuitry associated with output devices such as, for example, one or more audio outputs. The audio output may include one or more speakers built into the communication device 202, or an audio component that may be remotely coupled to the communication device 202.

The one or more speakers can be mono speakers, stereo speakers, or a combination of both. The audio component can be a headset, headphones or ear buds that may be coupled to the communication device 202 with a wire or wirelessly.

In an embodiment, the I/O circuitry module 210 may include display circuitry for providing a display visible to the user 102. For example, the display circuitry may include a screen (e.g., an LCD screen) that is incorporated in the communication device 202.

The display circuitry may include a movable display or a projecting system for providing a display of content on a surface remote from the communication device 202 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 206. Alternatively, the display circuitry may be operative to provide instructions to a remote display.

In addition, the communication device 202 includes the communication circuitry module 212. The communication circuitry module 212 may include any suitable communication circuitry operative to connect to a communication network and to transmit communications (e.g., voice or data) from the communication device 202 to other devices within the communications network. The communications circuitry module 212 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communications circuitry module 212 may be operative to create a communications network using any suitable communications protocol. For example, the communication circuitry module 212 may create a short-range communication network using a short-range communications protocol to connect to other devices. For example, the communication circuitry module 212 may be operative to create a local communication network using the Bluetooth® protocol to couple the communication device 202 with a Bluetooth® headset.

It may be noted that the computing device is shown to have only one communication operation; however, those skilled in the art would appreciate that the communication device 202 may include one more instances of the communication circuitry module 212 for simultaneously performing several communication operations using different communication networks. For example, the communication device 202 may include a first instance of the communication circuitry module 212 for communicating over a cellular network, and a second instance of the communication circuitry module 212 for communicating over Wi-Fi or using Bluetooth®.

In an embodiment, the same instance of the communications circuitry module 212 may be operative to provide for communications over several communication networks. In an embodiment, the communication device 202 may be coupled a host device for data transfers, synching the communication device 202, software or firmware updates, providing performance information to a remote source (e.g., providing riding characteristics to a remote server) or performing any other suitable operation that may require the communication device 202 to be coupled to a host device. Several computing devices may be coupled to a single host device using the host device as a server. Alternatively or additionally, the communication device 202 may be coupled to the several host devices (e.g., for each of the plurality of the host devices to serve as a backup for data stored in the communication device 202).

FIG. 3 illustrates a system 300 for capturing the advertisement skipping budget behavior of the one or more users, in accordance with various embodiments of the present disclosure. It may be noted that to explain the system elements of FIG. 3, references will be made to the system elements of the FIG. 1 and FIG. 2. The system 300 depicts an interconnection of the analytical and recommendation engine 112 with the user 102 associated with the device 106, one or more publishers 302, an advertisement exchange 304, one or more advertisers 306 and demand side platform 308.

The analytical and recommendation engine 112 captures the advertisement skipping budget behavior of the one or more users for the one or more advertisements. The advertisement skipping budget behavior is based on the real-time skipping criterion. The real-time skipping criterion includes paying of a pre-determined amount by the user 102 for skipping the one or more advertisements in the one or more content. The pre-determined amount is decided by the real-time bidding algorithm. The real-time bidding algorithm includes real-time bidding of the one or more advertisement slots of the one or more publishers 302. In the real-time bidding algorithm, the pre-determined amount is decided by mapping a first pre-determined amount and a second pre-determined amount. The first pre-determined amount is decided on a real time basis by utilizing the real-time bidding algorithm and the second pre-determined amount is decided by the user 102 for skipping the one or more advertisements.

The one or more advertisers 306 participate in the real-time bidding for purchasing an advertisement slot of the one or more advertisement slots on a publisher of the one or more publishers 302. The advertisements exchange 304 controls real-time bidding process. An advertiser that bids the highest amount is declared a winner. The demand side platform 308 allows the one or more advertisers 306 to buy the one or more advertisement slots.

For example, an advertiser X, an advertiser Y and an advertiser Z are participating in the real time bidding process for purchasing an advertisement slot on a publisher website. The advertiser Y bids the highest amount and is declared as a winner. This bid amount is the first pre-determined amount. The first pre-determined amount is calculated based on at least one of compensation methods. The compensation methods include cost per click, cost per impression, cost per view and the like. Now, a user A wants to skip the one or more advertisements in a video running on a desktop and he/she has decided to pay a total of $0.2 for skipping the one or more advertisements in the video. This amount is the second pre-determined amount. In an embodiment of the present disclosure, the user A may decide to pay for an advertisement of the one or more advertisements or optimally for the one or more advertisements. In an embodiment of the present disclosure, the user A may skip one or more advertisements in a television show coming on a television.

In an embodiment of the present disclosure, the analytical and recommendation engine 112 may discharge the one or more third parties (the one or more advertisers 306) from bidding, thereby reducing demand and lowering the revenue.

Further, the first pre-determined amount and the second pre-determined amount are compared. The one or more advertisements are skipped when the first pre-determined amount comes out to be greater than the second pre-determined amount and the user 102 pay the first pre-determined amount for skipping the one or more advertisements. However, if the first pre-determined amount comes out to be smaller than the second pre-determined amount, then the one or more advertisements are not skipped in playing of the content.

The analytical and recommendation engine 112 captures and analyzes the advertisement skipping budget behavior of the user 102 over a period of time (say, a month) and transmits the advertisement skipping budget behavior along with the data of the user 102 to the third parties for re-targeting of the advertisements. For example, the analytical and recommendation engine 112 analyzes that a user U pays $0.2 for skipping the one or more advertisements every time during broadcasting of the sports matches for a month. The amount $0.2 is decided by the real-time skipping criterion (described above).

It may be noted that in FIG. 3, the analytical and recommendation engine 112 captures the advertisement skipping budget behavior of the user 102; however those skilled in the art would appreciate that the analytical and recommendation engine 112 may capture the advertisement skipping budget behavior of more number of users.

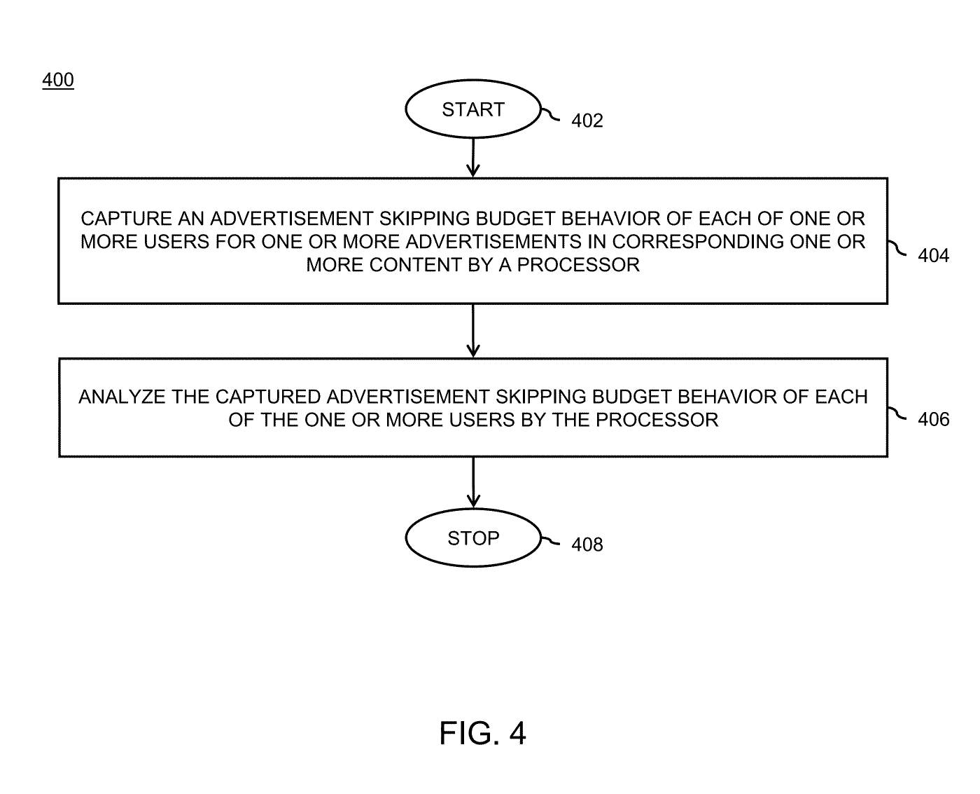

FIG. 4 illustrates a flowchart 400 for analyzing the advertisement skipping budget behavior of the one or more users, in accordance with various embodiments of the present disclosure. It may be noted that to explain the process elements of the FIG. 4, references will be made to the system elements of FIG. 1, FIG. 2 and FIG. 3. The flowchart 400 initiates at step 402. At step 404, the capturing module 204a captures the advertisement skipping budget behavior of the user 102-104 for the one or more advertisements in the corresponding one or more content. At step 406, the analyzing module 204b analyzes the captured advertisement skipping budget behavior of the user 102-104. The flowchart 400 terminates at step 408.

It may be noted that the flowchart 400 is explained to have above stated process steps; however, those skilled in the art would appreciate that the flowchart 400 may have more/less number of process steps which may enable all the above stated embodiments of the present disclosure.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method comprising:
capturing, with a processor, an advertisement skipping budget behavior of each of one or more users for one or more advertisements in corresponding one or more content, said advertisement skipping budget behavior being recorded for a pre-defined interval of time based on a real-time skipping criterion; and
analyzing, with said processor, said captured advertisement skipping budget behavior of each of said one or more users.

2. The computer-implemented method as recited in claim 1, wherein said advertisement skipping budget behavior being captured for an advertisement of each of said one or more advertisements in said corresponding one or more content.

3. The computer-implemented method as recited in claim 1, wherein said advertisement skipping budget behavior being captured for said one or more advertisements in a content of said one or more content.

4. The computer-implemented method as recited in claim 1, further comprising correlating, with said processor, data of each of said one or more users with said advertisement skipping budget behavior of each of said corresponding one or more users, wherein said data being based on a plurality of attributes corresponding to each of said one or more users, said plurality of attributes comprises at least one of age, gender, interest and browsing history.

5. The computer-implemented method as recited in claim 1, further comprising categorizing, with said processor, said one or more users based on said correlation of said advertisement skipping budget behavior of each of said corresponding one or more users for said one or more advertisements with said data of corresponding said one or more users.

6. The computer-implemented method as recited in claim 1, further comprising maintaining a database, with said processor, of each of said one or more users, wherein said database comprises said advertisement skipping budget behavior of each of said one or more users, said data corresponding to each of said one or more users and said categorized one or more users.

7. The computer-implemented method as recited in claim 1, further comprising transmitting, with said processor, said advertisement skipping budget behavior of each of said corresponding one or more users, and said data corresponding to each of said one or more users to one or more third parties for re-targeting of said one or more advertisements.

8. The computer-implemented method as recited in claim 7, wherein said one or more third parties comprises at least one of one or more advertising platforms and one or more advertisement re-targeting platforms.

9. A computer program product comprising a non-transitory computer readable medium storing a computer readable program, wherein said computer readable program when executed on a computer causes said computer to perform steps comprising:
capturing an advertisement skipping budget behavior of each of one or more users for one or more advertisements in corresponding one or more content, said advertisement skipping budget behavior being recorded for a pre-defined interval of time based on a real-time skipping criterion; and
analyzing said captured advertisement skipping budget behavior of each of said one or more users.

10. The computer program product as recited in claim 9, wherein said computer readable program when executed on said computer causes said computer to perform a further step of categorizing said one or more users based on said correlation of said advertisement skipping budget behavior of each of said corresponding one or more users for said one or more advertisements, and data of corresponding said one or more users, said data being based on a plurality of attributes corresponding to each of said one or more users, and wherein said plurality of attributes comprises at least one of age, gender, interest and browsing history.

11. The computer program product as recited in claim 9, wherein said computer readable program when executed on said computer causes said computer to perform a further step of transmitting said advertisement skipping budget behavior of each of said corresponding one or more users, and said data corresponding to each of said one or more users to one or more third parties for re-targeting of said one or more advertisements, and wherein said one or more third parties comprises at least one of one or more advertising platforms and one or more advertisement re-targeting platforms.

12. An analytical and recommendation engine comprising:
a capturing module, in a processor, said capturing module being configured to capture an advertisement skipping budget behavior of each of one or more users for one or more advertisements in corresponding one or more content, said advertisement skipping budget behavior being recorded for a pre-defined interval of time based on a real-time skipping criterion; and
an analyzing module, in said processor, said analyzing module being configured to analyze said captured advertisement skipping budget behavior of each of said one or more users.

13. The analytical and recommendation engine as recited in claim 12, further comprising a correlation engine, in said processor, said correlation engine being configured to correlate data of each of said one or more users with said advertisement skipping budget behavior of each of said corresponding one or more users, wherein said data being based on a plurality of attributes corresponding to each of said one or more users.

14. The analytical and recommendation engine as recited in claim 13, wherein said plurality of attributes comprises at least one of age, gender, interest and browsing history.

15. The analytical and recommendation engine as recited in claim 12, further comprising a categorization module, in said processor, said categorization module being configured to categorize said one or more users based on said correlation of said advertisement skipping budget behavior of each of said corresponding one or more users for said one or more advertisements with said data of corresponding said one or more users.

16. The analytical and recommendation engine as recited in claim 12, further comprising a database in said processor of each of said one or more users, said database comprises said advertisement skipping budget behavior of each of said one or more users, said data corresponding to each of said one or more users and said categorized one or more users.

17. The analytical and recommendation engine as recited in claim 12, further comprising a transmission module, in said processor, said transmission module being configured to transmit said advertisement skipping budget behavior of each of said corresponding one or more users, and said data corresponding to each of said one or more users to one or more third parties for re-targeting of said one or more advertisements.

18. The analytical and recommendation engine as recited in claim 17, wherein said one or more third parties comprises at least one of one or more advertising platforms and one or more advertisement re-targeting platforms.

19. The analytical and recommendation engine as recited in claim 12, wherein said advertisement skipping budget behavior being captured for an advertisement of each of said one or more advertisements in said corresponding one or more content.

20. The analytical and recommendation engine as recited in claim 12, wherein said advertisement skipping budget behavior being captured for said one or more advertisements in a content of said one or more content.
